(19) United States
(12) Patent Application Publication
(10) Pub. No.: US 2015/0169708 A1
(43) Pub. Date: Jun. 18, 2015

(54) PROVIDING RECENTLY SELECTED IMAGES

(71) Applicant: Google Inc., Mountain View, CA (US)

(72) Inventors: Yang Song, San Jose, CA (US); Thomas J. Duerig, Sunnyvale, CA (US)

(73) Assignee: Google Inc., Mountain View, CA (US)

(21) Appl. No.: 14/249,523

(22) Filed: Apr. 10, 2014

Related U.S. Application Data
(63) Continuation of application No. 13/467,463, filed on May 9, 2012, now abandoned.
(60) Provisional application No. 61/637,415, filed on Apr. 24, 2012.

(51) Int. Cl. G06F 17/30

(52) U.S. Cl. CPC G06F 17/30554

(57) ABSTRACT

A computer implemented technique for presenting selected image search results is presented. The technique includes obtaining a first query at a first time and obtaining a first set of image search results responsive to the first query. The technique also includes providing the first set of image search results in response to the first query and obtaining input data reflecting a selection of at least one of the first set of image search results. The technique further includes obtaining a second query at a second time subsequent to the first time and obtaining a second set of image search results responsive to the second query. The technique further includes providing the second set of image search results together with the selected at least one of the first set of image search results.

### CROSS-REFERENCE TO RELATED APPLICATIONS

This application is a continuation of U.S. application Ser. No. 13/467,463, filed May 9, 2012, which claims the benefit of U.S. Provisional Application No. 61/637,415, filed Apr. 24, 2012, the contents of both of which are incorporated by reference.

### BACKGROUND

The techniques provided herein relate to presenting image search results.

Internet search engines provide information about internet-accessible resources, e.g., web pages, documents, and images, in response to a user's query. For example, a user receives search results in response to the user submitting a query to a search engine using a client computer. A search result can include one or both of a portion of the associated resource and a thumbnail version of an image from the resource.

### SUMMARY

According to various implementations, a computer implemented method of presenting selected image search results is presented. The method includes obtaining a first query at a first time and obtaining a first set of image search results responsive to the first query. The method also includes providing the first set of image search results in response to the first query and obtaining input data reflecting a selection of at least one of the first set of image search results. The method further includes obtaining a second query at a second time subsequent to the first time and obtaining a second set of image search results responsive to the second query. The method further includes providing the second set of image search results together with the selected at least one of the first set of image search results.

The above implementations can optionally include one or more of the following. The second query can identical to the first query. The implementations can determine a similarity between the first query and the second query. The determining a similarity can include calculating a ratio of (1) unique search terms common to the first query and the second query to (2) unique search terms for the first query and the second query. The determining a similarity can include calculating a ratio of (1) unique, up to synonymy, search terms common to the first query and the second query to (2) unique, up to synonymy, search terms for the first query and the second query. The determining a similarity can include calculating a ratio of (1) unique, up to pronunciation equivalence, search terms common to the first query and the second query to (2) unique, up to pronunciation equivalence, search terms for the first query and the second query. The determining a similarity can include calculating a ratio of (1) unique, up to synonymy and pronunciation equivalence, search terms common to the first query and the second query to (2) unique, up to synonymy and pronunciation equivalence, search terms for the first query and the second query. The determining a similarity can include calculating a ratio of (1) search results common to the first query and the second query to (2) search results for the first query and the second query. The determining a similarity can include determining whether the second query is a refinement of the first query. The technique can include providing a hyperlink associated with the selected at least one of the first set of image search results, where the hyperlink is configured to activate a social media function associated with the selected at least one of the first set of image search results. The social media function can include providing the associated image to a social media website.

According to various implementations, a system is presented. The system can include one or more computers configured to perform the following operations. The system can obtain a first query at a first time and obtaining a first set of image search results responsive to the first query. The system can also provide the first set of image search results in response to the first query and obtain input data reflecting a selection of at least one of the first set of image search results. The system can also obtain a second query at a second time subsequent to the first time and obtain a second set of image search results responsive to the second query. The system can further provide the second set of image search results together with the selected at least one of the first set of image search results.

The above implementations can optionally include one or more of the following. The second query can be identical to the first query. The system can include one or more computers configured to determine a similarity between the first query and the second query. The one or more computers configured to determine a similarity between the first query and the second query can be configured to calculate a ratio of (1) unique search terms common to the first query and the second query to (2) unique search terms for the first query and the second query. The one or more computers configured to determine a similarity between the first query and the second query can be configured to calculate a ratio of (1) unique, up to synonymy, search terms common to the first query and the second query to (2) unique, up to synonymy, search terms for the first query and the second query. The one or more computers configured to determine a similarity between the first query and the second query can be configured to calculate a ratio of (1) unique, up to pronunciation equivalence, search terms common to the first query and the second query to (2) unique, up to pronunciation equivalence, search terms for the first query and the second query. The one or more computers configured to determine a similarity between the first query and the second query can be configured to calculate a ratio of (1) unique, up to synonymy and pronunciation equivalence, search terms common to the first query and the second query to (2) unique, up to synonymy and pronunciation equivalence, search terms for the first query and the second query. The one or more computers configured to determine a similarity between the first query and the second query can be configured to calculate a ratio of (1) search results common to the first query and the second query to (2) search results for the first query and the second query. The one or more computers configured to determine a similarity between the first query and the second query can be configured to determine whether the second query is a refinement of the first query. The system can perform the operations of providing the second set of image search results together with the selected at least one of the first set of image search results together with a hyperlink associated with the selected at least one of the first set of image search results, where the hyperlink is configured to activate a social media function associated with the selected at least one of the first set of image search results. The social media function can include providing the associated image to a social media website.

According to various implementations, a computer readable media containing instructions is presented. The instructions, when executed by one or more processors, can cause the one or more processors to perform the following. The one or more processors can obtain a first query at a first time and obtaining a first set of image search results responsive to the first query. The one or more processors can provide the first set of image search results in response to the first query and obtain input data reflecting a selection of at least one of the first set of image search results. The one or more processors can obtain a second query at a second time subsequent to the first time and obtain a second set of image search results responsive to the second query. The one or more processors can provide the second set of image search results together with the selected at least one of the first set of image search results.

Presented techniques include certain technical advantages. Because some implementations provide a user with previously-selected image search results, such implementations can reduce network traffic and client computer processor load. For example, a user can enter a first query at a client computer and receive image search results. The user can select some such image search results. Later, in response to a second query, some implementations can provide both search results responsive to the second query and previously-selected image search results responsive to the first query. This technique allows the user to receive multiple sets of search results, responsive to two different search queries, in response to a single (second) query. As a result, the user need not re-enter the first query, nor direct a browser back to prior results, both of which require more network bandwidth and processor time than a presentation of two sets of search results as presented herein.

### DESCRIPTION OF DRAWINGS

The accompanying drawings, which are incorporated in and constitute a part of this specification, illustrate implementations of the described technology. In the figures:

FIG. 1 is a schematic diagram of a presentation of new and previously selected image search results according to various implementations;

FIG. 2 is a schematic diagram of a system according to various implementations; and

FIG. 3 is a flowchart of a method according to various implementations.

### DETAILED DESCRIPTION

Users gain information about internet-accessible resources by providing a query to a search engine. In response to receiving a query, the search engine provides search results that include excerpts, e.g., snippets, and/or thumbnail sized images from such resources. The user can select a specific image search result by, e.g., clicking on it. Later, when the user returns to the search engine and enters an additional query, the search engine returns new search results responsive to the additional query. In some implementations, the search engine can provide the new search results together with the previously selected image search results. This provides the user with the opportunity to re-visit previously selected image search results without having to re-enter the original query, direct the user's browser back, or otherwise re-trace the user's online steps.

Reference will now be made in detail to example implementations, which are illustrated in the accompanying drawings. Where possible the same reference numbers will be used throughout the drawings to refer to the same or like parts.

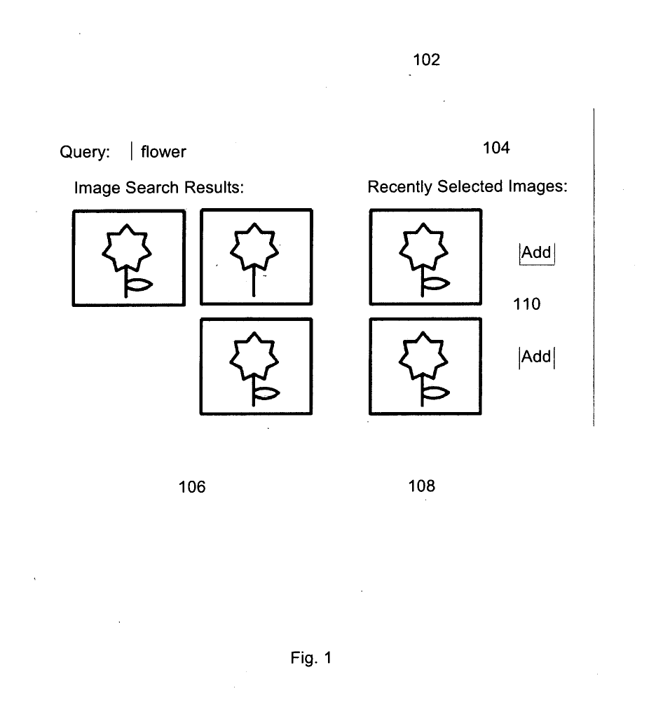

FIG. 1 is an example schematic diagram, according to various implementations, of a presentation 102 of new and previously selected image search results. Presentation 102 may represent all, or a portion, of a search web page. In FIG. 1, presentation 102 includes field 104 into which a user has entered the search query “flower”. Below that, presentation 102 includes new image search results 106 responsive to the query. Presentation 102 also includes previously selected image search results 108, which the user previously selected from a set of search results by, for example, clicking on them. Presentation 102 includes the previously selected image search results 108 in a separate region from that of new image search results 106.

Presentation 102 also contains social media widgets 110 next to the previously selected search results 108. In particular, each previously selected image search result 108 is next to a corresponding social media widget. In some implementations, when the user activates a widget, it causes the associated image to be added to the user's social media account for display to the user's social media group.

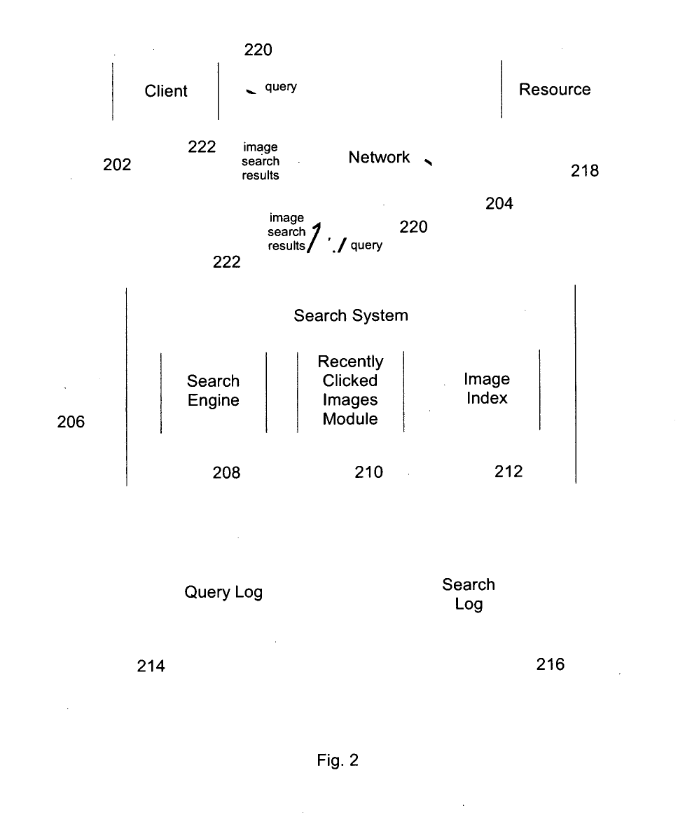

FIG. 2 is a schematic diagram of a system according to various implementations. Thus, FIG. 2 illustrates various hardware, software, and other resources that can be used in implementations of system 206 according to presented techniques. System 206 is coupled to network 204, for example, the internet. Client 202 is also coupled to network 204 such that system 206 and client 202 are communicatively coupled. Client 202 can be a personal computer, tablet computer, desktop computer, or any other computing device.

Using a web browser, a user of client 202 sends a query 220 to system 206 through network 204. System 206 receives query 220 and processes it using search engine 208. Search engine 208 obtains image and possibly other search results. For image search results, search engine 208 utilizes image index 212 to process the query. System 206 can utilize a corresponding index for other types of search results. Image index 212 includes thumbnail images in association with keywords. System 206 can retrieve original copies of such images beforehand from, for example, resource 218, which can be, for example, a web page or a document, and store corresponding thumbnail images in image index 212. Using conventional techniques, search engine 208 identifies images in image index 212 that are responsive to query 220 based on matching keywords in image index 212 to query 220. (Although keyword matching is discussed here as an example, implementations can use other techniques for identifying images responsive to the user's query instead of, or in the alternative.) Query log 214 stores anonymized data reflecting users' queries. In some implementations, system 206 stores query 220 in query log 214.

System 206 conveys the responsive image search results 222 back to client 202 through network 204. Client 202 displays such search results, for example, in a web browser. The user selects some of the search results by clicking on them, for example. Clicking on an image search result can activate a uniform resource locator (URL) that directs the user's browser to a web page that contains the image and resource 218 in which the image appeared.

Search log 216 includes data reflecting the search results that the user selected. Thus, system 206 stores data reflecting the user's selections in search log 216. Search log 216 associates such data with the corresponding query log record, that is, the query log record for the search that gave rise to the search results that the user selected.

Recently clicked images module 210 can process a subsequent query that client 202 sends to system 206 through network 204. In particular, recently clicked images module 210 interacts with query log 214 and search log 216 to identify prior searches and image search results selected by the user. System 206 then provides search results responsive to the subsequent query together with search results that the user previously selected. An example presentation of such results appears in FIG. 1.

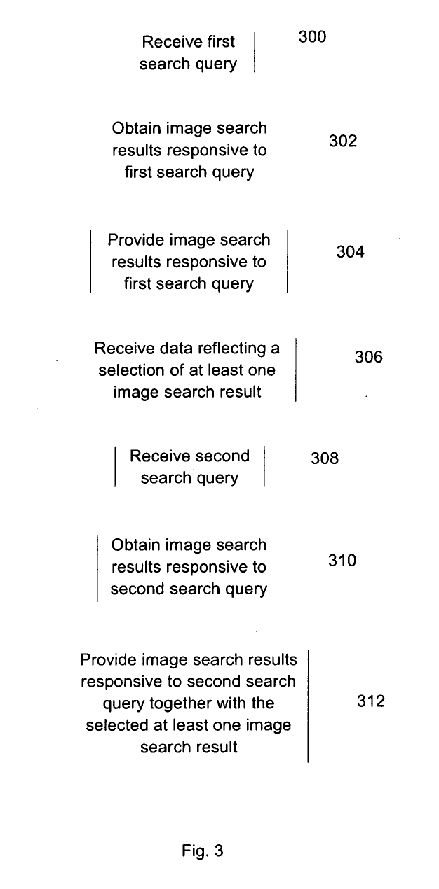

FIG. 3 is a flowchart of a method according to various implementations. At block 300, system 206 receives a search query, for example, sent over network 204 from client 202 operated by a user. The user enters the search query into a query field of a search web page, which is opened in a web browser executing on the user's personal computer or other computing device. The search query can be in the form of a natural language phrase or question, or can include of one or more search terms. The user's computing device automatically formats the search query in any of several computer interpretable languages, by way of non-limiting example, HTML or XML, and communicates the query using any of several protocols, again by way of non-limiting example, HTTP.

At block 302, system 206 obtains image search results corresponding to the search query received at block 300. In some implementations, system 206 accesses image index 212 and matches the search query to keywords in image index 212. System 206 then retrieves thumbnail images corresponding to such matches from image index 212 and forms image search results therefrom. Such search results can include the thumbnail images linked to the resources from which the original images were retrieved to create the thumbnail images.

At block 304, system 206 provides the image search results responsive to the query received at block 300 to client 202. System 206 provides the image search results in the form of a set of instructions, which can be formatted using, for example, hypertext markup language (HTML) or extensible markup language (XML), and sends the image search results to the user's computing device using hypertext transfer protocol (HTTP). The instructions can specify a layout of the image search results. For example, the instructions can specify how the search results obtained at block 302 are to be displayed to the user on client 202 in a web page. In some implementations, the instructions specify that the image search results are displayed on a formatted web page in a grid pattern, e.g., uniformly spaced, or tile pattern, e.g., arranged to substantially cover a region of the document, while allowing for spacing between adjacent image search results.

The instructions for the search results of block 304 can further specify that the corresponding document, e.g., search web page, display the search query in addition to the images. In some implementations, the search query can be displayed by populating a search dialog box with the query, such that the user can resubmit the original query, or revise and submit a modified, refined or entirely different query.

At block 306, recently clicked images module 210 receives data reflecting the user's selection of image search results and stores such data in search log 216. A user can “select” an image search result using a variety of techniques. For example, a user's mouse clicking on an image search result constitutes a selection of such an image search result. A user can hover a mouse pointer, e.g., cursor, over an image search result, which can constitute a selection of the image. Other selection techniques are also possible, such as the user utilizing a keyboard TAB button to highlight an image search result and then activating an ENTER button to select such image search result. Selection techniques are not limited to those recited above.

Implementations can receive a user's selection of image search results according to any of a variety of techniques. For example, the user can be logged in to a user account at the time of the selection. That is, a user can provide an identification, e.g., user name, and authentication, e.g., password, to system 206. System 206 can use this information to associate the user's selections with a user's session. In some implementations, system 206 can request that the user's browser set aside information regarding the image search results the user has selected.

At block 308, system 206 receives a second search query from client 202. Such a query can be identical to the query of block 300, can be similar to the query of block 300, or can be entirely different from the query of block 300. The user can submit such a query by entering it into query field of the search web page.

In some implementations, if the second query of block 308 is not identical to the query of block 300, system 206 makes a determination as to whether the second query is sufficiently similar to the query obtained at block 300 before the method is allowed to proceed to block 310. If the queries are sufficiently similar, in some implementations, the method of FIG. 3 proceeds to block 310. In some implementations, if the queries are not sufficiently similar, the method of FIG. 3 can terminate at block 308, and system 206 can respond in a standard manner by obtaining and presenting search results appropriate for the second query. In some implementations, the method of FIG. 3 proceeds regardless as to whether the queries are sufficiently similar; in such implementations, the system does not compare the first and second queries.

There are several metrics of query similarity that can be employed. In some implementations, the search results corresponding to the two queries are compared for common results. A numerical characterization for such a metric can be, by way of non-limiting example, of the form:

S₁=C/D Equation 1

In Equation 1, the term S₁ represents a commonality metric whose value lies in the interval [0, 1] inclusive, C represents the number of unique search results common to both queries, and D represents the number of unique search results for both the first and second queries. If S₁ exceeds a predetermined threshold, the queries can be considered sufficiently similar. Example thresholds include, by way of non-limiting example, any quantity between 0 and 1.

Another suitable metric for query similarity is based on common search terms. A numerical characterization for such a metric can be of the form, by way of non-limiting example:

S₂=X/Y Equation 2

In Equation 2, the term S₂ represents a commonality metric whose value lies in the interval [0, 1] inclusive, X represents the number of unique search terms common to both queries, and Y represents the number of unique search terms for both the first and second queries. If S₂ exceeds a predetermined threshold, the queries can be considered sufficiently similar. Example thresholds include, by way of non-limiting example, any quantity between 0 and 1.

In some implementations, search terms are considered identical, for counting purposes regarding Equation 2, if such terms are synonyms. In such implementations, for example, a first search query of “flower sun water” and a second query of “flower sun H2O” can have a similarity metric of S₂=1 because “water” and “H2O” can be considered synonyms (and therefore X=Y=3).

In some implementations, search terms are considered identical, for counting purposes regarding Equation 2, if such terms resolve to the same SOUNDEX code. In such implementations, for example, a first search query of “flower sun water” and a second query of “flower son watur” can have a similarity metric of S₂=1 because “sun” and “son” resolve to the same SOUNDEX code, as do “water” and “watur”.

A variation of the determination of Equation 2 has to do with query refinements. In some implementations, a first query is a “refinement” of a second query if the first query contains all search terms (or synonyms or SOUNDEX equivalents thereof) of the second query. Thus, for example, “sun flower water soil air” is a refinement of “sun flower soil”. Similarly, “son flower H2O soil air” is a refinement of “sun flower water” because, as discussed above, “H2O” is a synonym of “water” and “son” is SOUNDEX equivalent to “sun”. In some implementations, two queries are sufficiently similar if the second query, e.g., a query obtained at block 308, is any refinement of the first query, e.g., a query obtained at block 300.

Other suitable metrics for determining search query similarity include Edit Distance, Hamming Distance and Sorensen-Dice coefficient, or other known techniques. For implementations that utilize similarity metrics, such similarity metrics are not limited to those explicitly presented herein; other metrics can be used.

At block 310, system 206 obtains search results corresponding to the second search query, which was received at block 308. In some implementations, system 206 accesses image index 212 and matches the second search query to keywords in image index 212. System 206 then retrieves thumbnail images corresponding to such matches from image index 212 and forms search results therefrom. Such search results include thumbnail images corresponding to the original images present in the online resources.

At block 312, system 206 provides the image search results responsive to the second query to client 202 along with previously selected image search results. The system provides the image search results in the form of a set of instructions, which can be formatted using, for example, HTML or XML, and sent to the user's computing device using HTTP. The instructions can specify a layout of the image search results. In some implementations, the instructions specify that the image search results are displayed on a formatted web page in a grid, e.g., uniformly spaced, or tile, e.g., arranged to substantially cover a region of the document while allowing for spacing between adjacent images, with the image search results responsive to the second query appearing in one region, and the previously selected image search results appearing in another region. That is, the second query results can be set forth in a particular region, apart from a region containing the previously selected image search results.

All image search results selected per block 306 can be presented, or only some such image search results. If only some such image search results are presented, the presented image search results can be those that are highest ranked according to the search results obtained at block 302 if such search results are obtained together with a ranking.

The previously selected image search results can be formatted so as to be associated, e.g., associated by proximity, to any of a variety of widgets. Such widgets can be, in some implementations, buttons or hyperlinks. The widgets can be for social media web sites. In such implementations, the user can be logged in to a social media web site by providing an identification, e.g., user name, and authentication, e.g., password, to such website. The widgets can allow a user to share, recommend, present, link to, forward, upload or comment on the associated images on a social media web site. Each image can be associated with one or more such widgets, and a different widget can be present for each unique function.

Note that the technique presented in reference to FIG. 3 may be modified by, for example, removing or changing certain blocks. For example, while block 308 refers to receiving a search query, other types of requests may be substituted. In some implementations, the request can take the form of the user requesting access to the same web page that was used to enter the search query of block 300. This can take the form of the user entering the appropriate URL into a web browser, the user navigating the browser to the appropriate web page, e.g., using the browser's FORWARD or BACK buttons, or the user causing a re-load of the web page, e.g., by activating the browser's re-load button. If the request of a modified block 308 is not a search query, then block 310 may be omitted, and block 312 modified so as to present only the previously selected search results.

In general, systems capable of performing the presented techniques may take many different forms. Further, the functionality of one portion of the system may be substituted into another portion of the system. Each hardware component may include one or more processors coupled to random access memory operating under control of, or in conjunction with, an operating system. The system can include network interfaces to connect with clients through a network. Such interfaces can include one or more servers. Appropriate networks include the internet, as well as smaller networks such as wide area networks (WAN) and local area networks (LAN). Networks internal to businesses or enterprises are also contemplated Further, each hardware component can include persistent storage, such as a hard drive or drive array, which can store program instructions to perform the techniques presented herein. That is, such program instructions can serve to control search operations and to analyze and respond to search queries as presented. Other configurations of computer system 206, associated network connections, and other hardware, software, and service resources are possible.

The foregoing description is illustrative, and variations in configuration and implementation are possible. For example, resources described as singular can be plural, and resources described as integrated can be distributed. Further, resources described as multiple or distributed can be combined. The scope of the presented techniques is accordingly intended to be limited only by the following claims.

1. (canceled)

2. A computer-implemented method comprising:
receiving a search query from a user;
identifying another search query that was received from the user before the search query was received;
determining a similarity score that reflects a level of similarity between the search query and the other search query that was received from the user before the search query was received;
determining that the similarity score satisfies a predetermined similarity threshold;
in response to determining that the similarity score satisfies a predetermined similarity threshold, determining that the search query is similar to the other search query that was received from the user before the search query was received; and
in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query.

3. The method of claim 2, wherein receiving a search query from a user comprises:
receiving an image search query that includes one or more search terms.

4. The method of claim 3, wherein determining a similarity score that reflects a level of similarity between the search query and the other search query that was received from the user before the search query was received, comprises:
determining the similarity score based at least on a number of search terms in the search query that are similar to search terms in the other search query.

5. The method of claim 4, wherein determining the similarity score based at least on the number of search terms in the search query that are similar to search terms in the other search query comprises:
determining the number of search terms that are identical, synonyms, or acoustically similar between the search query and the other search query.

6. The method of claim 2, wherein determining a similarity score that reflects a level of similarity between the search query and the other search query that was received from the user before the search query was received, comprises:
determining the similarity score based on least on a quantity of image search results for the search query that are similar to image search results of the other search query.

7. The method of claim 2, wherein in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query, comprises:
providing a search results page that includes the particular search result that is identified in response to the search query in a first region and the image search result that was identified in response to the other search query, and that was selected by the user in response to the other search query, in a second region apart from the first region.

8. The method of claim 2, wherein in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query, comprises:
selecting the image search result that was identified in response to the other search query based on a ranking of the image search result for the other search query.

9. A system comprising:
one or more computers and one or more storage devices storing instructions that, when executed by the one or more computers, cause the one or more computers to perform operations comprising:
receiving a search query from a user;
identifying another search query that was received from the user before the search query was received;
determining a similarity score that reflects a level of similarity between the search query and the other search query that was received from the user before the search query was received;
determining that the similarity score satisfies a predetermined similarity threshold;
in response to determining that the similarity score satisfies a predetermined similarity threshold, determining that the search query is similar to the other search query that was received from the user before the search query was received; and
in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query.

10. The system of claim 9, wherein receiving a search query from a user comprises:
receiving an image search query that includes one or more search terms.

11. The system of claim 10, wherein determining a similarity score that reflects a level of similarity between the search query and the other search query that was received from the user before the search query was received, comprises:
determining the similarity score based at least on a number of search terms in the search query that are similar to search terms in the other search query.

12. The system of claim 11, wherein determining the similarity score based at least on the number of search terms in the search query that are similar to search terms in the other search query comprises:
determining the number of search terms that are identical, synonyms, or acoustically similar between the search query and the other search query.

13. The system of claim 9, wherein determining a similarity score that reflects a level of similarity between the search query and the other search query that was received from the user before the search query was received, comprises:
determining the similarity score based on least on a quantity of image search results for the search query that are similar to image search results of the other search query.

14. The system of claim 9, wherein in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query, comprises:
providing a search results page that includes the particular search result that is identified in response to the search query in a first region and the image search result that was identified in response to the other search query, and that was selected by the user in response to the other search query, in a second region apart from the first region.

15. The system of claim 9, wherein in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query, comprises:
selecting the image search result that was identified in response to the other search query based on a ranking of the image search result for the other search query.

16. A non-transitory computer-readable medium storing software comprising instructions executable by one or more computers which, upon such execution, cause the one or more computers to perform operations comprising:
receiving a search query from a user;
identifying another search query that was received from the user before the search query was received;
determining a similarity score that reflects a level of similarity between the search query and the other search query that was received from the user before the search query was received;
determining that the similarity score satisfies a predetermined similarity threshold;
in response to determining that the similarity score satisfies a predetermined similarity threshold, determining that the search query is similar to the other search query that was received from the user before the search query was received; and
in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query.

17. The medium of claim 16, wherein receiving a search query from a user comprises:
receiving an image search query that includes one or more search terms.

18. The medium of claim 17, wherein determining a similarity score that reflects a level of similarity between the search query and the other search query that was received from the user before the search query was received, comprises:
determining the similarity score based at least on a number of search terms in the search query that are similar to search terms in the other search query.

19. The medium of claim 18, wherein determining the similarity score based at least on the number of search terms in the search query that are similar to search terms in the other search query comprises:
determining the number of search terms that are identical, synonyms, or acoustically similar between the search query and the other search query.

20. The medium of claim 16, wherein determining a similarity score that reflects a level of similarity between the search query and the other search query that was received from the user before the search query was received, comprises:
determining the similarity score based on least on a quantity of image search results for the search query that are similar to image search results of the other search query.

21. The medium of claim 16, wherein in response to determining that the search query is similar to the other search query that was received from the user before the search query was received, providing a search results page that includes (i) a particular search result that is identified in response to the search query, and (ii) an image search result that was identified in response to the other search query, and that was selected by the user in response to the other search query, comprises:
providing a search results page that includes the particular search result that is identified in response to the search query in a first region and the image search result that was identified in response to the other search query, and that was selected by the user in response to the other search query, in a second region apart from the first region.
